(19) United States
(12) Patent Application Publication
(10) Pub. No.: US 2026/0176123 A1
(43) Pub. Date: Jun. 25, 2026

(54) FILLING MACHINE FOR FILLING CONTAINERS WITH LIQUIDS

(71) Applicant: GRUPPO BERTOLASO S.P.A., Zimella (IT)

(72) Inventors: Lorenzo RIGONI, Cologna Veneta (IT); Giovanni MAZZON, Lobia di San Bonifacio (IT); Enrico RAMBALDI, San Martino Buon Albergo (IT); Mauro LANCEROTTO, Pressana (IT); Giacomo ZAMBELLI, Concamarise (IT); Gianluca STELLA, Noventa Vicentina (IT); Walter BERTO, Montagnana (IT)

(21) Appl. No.: 19/424,372

(22) Filed: Dec. 18, 2025

(30) Foreign Application Priority Data
Dec. 19, 2024 (IT) 102024000029250

(51) Int. Cl. B67C 3/26; B67C 3/16; B67C 3/24; B67C 3/28

(52) U.S. Cl. CPC B67C 3/2634; B67C 3/16; B67C 3/24; B67C 3/28

(57) ABSTRACT

Filling machine including multiple valve groups, each having a supply channel connected to a containment tank, a first shutter actuatable by a first actuation body in order to open and close the supply duct, a return tube placed in the supply channel, and an evacuation chamber connected to the return tube and traversed by the first actuation body. In addition, each valve group comprises a first flexible membrane, placed as an upper hermetic closure of the supply channel to separate the latter from the evacuation chamber, and a second flexible membrane, placed as an upper closure of the evacuation chamber. The membranes are arranged for being deformed by the moving first actuation body.

### FIELD OF APPLICATION

The present invention regards a filling machine for filling containers with liquids. The present machine is inserted in the field of industrial bottling plants and is intended to be used for filling containers, such as for example bottles or cans, with liquids of alimentary type, such as for example wines, liqueurs, mineral water, fruit juices, etc.

The present machine is preferably employable within bottling lines typically comprising a rinsing machine, a capping machine, a capsule machine or also, in the more downstream part of the line, a labeling machine and a packaging machine.

### State of the Art

The filling machines for alimentary liquid products are conventionally provided with a fixed support frame, on which a rotary carousel is rotatably mounted, which supports a cylindrical tank in which a liquid to be bottled is contained. Peripherally fixed to the tank are a plurality of valve groups adapted to convey the liquid contained in the tank within underlying containers to be filled, such as in particular bottles.

For such purpose, each valve group comprises a support body, which is fixed to the rotary carousel, in particular outside the containment tank, is provided with an internal supply channel extended between an upper end and a lower mouth sealingly coupled to the head of the container to be filled and through which the liquid is susceptible of transiting from the containment tank to the container itself.

Each valve group comprises, in addition, a return tube for the air, which is placed in the supply channel and, during the filling of the container, penetrates with an open lower end thereof within the latter, in a manner such that the air present in the container is evacuated by means of the return tube. When the liquid in the container reaches the open lower end of the return tube, it interrupts the exit of the air from the container and consequently the dispensing of the liquid into the container itself.

In particular, the upper end of the return tube is in communication with a return circuit of the filling machine, which is arranged in order to receive the air coming from the containers and the possible fraction of liquid that rises along the return tube during the filling of the container, in order to carry out a suitable evacuation or a suitable recovery of the liquid itself.

In addition, each valve group comprises movement means placed above the supply channel and comprising a first piston with pneumatic actuation, which is partially inserted in the supply channel (in particular through the upper end of the latter), carries the return tube fixed thereto and is actuatable to be moved vertically in order to move the return tube itself. In addition, each valve group comprises a first shutter, which is placed to intercept the supply channel and is actuated to allow or not allow the dispensing of the liquid towards the corresponding container. In particular, the shutter is fixed to the return tube, in a manner such that the movement of the latter due to the action of the piston with pneumatic actuation opens or closes the shutter itself so as to adjust the flow of liquid towards the container.

In addition, the valve group comprises a second shutter arranged in order to open and close the upper end of the return tube during the different steps of the filling process.

On this matter, the movement means comprise a second piston, which is slidably mounted in an internal seat of the aforesaid first piston and carries, fixed thereto, the second shutter in order to move it so as to open or close the return tube.

The first piston is sealingly placed within the supply channel, so as to prevent seeping of liquid or air coming from the supply duct itself. Additionally, the second piston is sealingly placed within the first piston in order to prevent seeping of air coming from the air return tube.

In order to ensure the seal between the aforesaid mutually movable parts (i.e. between the first piston and the support body of the valve group, and between the second piston and the first piston), annular gaskets are provided between such parts.

More in detail, the valve group comprises a first gasket (e.g. lip gasket), which is fixed to the first piston and is placed in contact with the lateral wall of the supply channel in order to hermetically isolate the latter with respect to the outside.

In addition, the group comprises a second gasket (e.g. lip gasket), which is fixed to the second piston and comes into contact with the wall of the internal seat of the first piston, so as to isolate the upper end of the air return tube (and also the return circuit) from the outside environment.

The filling machines described briefly up to now have in practice shown that they do not lack drawbacks.

The main drawback lies in the fact that the aforesaid gaskets are subjected to dragging during the movement of the pistons on which they are fixed, since the first gasket drags on the lateral wall of the supply channel during the movement of the first piston and the second gasket drags on the wall of the internal seat during the movement of the second piston, involving a quick wear over time of the gaskets themselves. Since the filling machines with rotary carousel are employed for bottling a high number of bottles per unit of time (up to even tens of thousands per hour), the filling cycle of each valve group is extremely short and therefore the pistons are moved with high frequency. For these reasons in such type of filling machine, the gaskets are worn very quickly, consequently requiring frequent stop periods for executing maintenance (e.g. substitution) of the gaskets themselves, consequently reducing the operative efficiency of the bottling plant in which the filling machine is employed.

A further drawback lies in the fact that the gaskets (in particular lip gaskets) facilitate the deposition of liquid, which, being difficult to wash, remains in contact with the gaskets themselves even for a long period after the end of the filling step. The presence of a deposit of liquid that is hard to wash therefore places at risk of contamination all the liquid introduced into the containers that comes into contact with the lip gaskets during the filling of the containers themselves.

### Presentation of the Invention

In this situation, the problem underlying the present invention is therefore that of overcoming the drawbacks manifested by the filling machines of known type by providing a filling machine which allows considerable reducing the maintenance interventions, in particular due to the wear of sealing elements.

Further object of the present invention is to attain a filling machine, which allows ensuring the bottling of the liquid in completely hygienic conditions, in particular preventing even the minimum presence of liquid contamination.

Further object of the present invention is to attain a filling machine, which allows carrying out maintenance operations on the valve groups in a particularly simple and quick manner.

Further object of the present invention is to provide a filling machine which is capable of operating in an entirely efficient manner, even with alimentary liquids that must be bottled at high temperatures.

Further object of the present invention is to provide a filling machine that is structurally simple and inexpensive to produce.

Further object of the present invention is to provide a filling machine that is entirely efficient and reliable in operation.

### BRIEF DESCRIPTION OF THE DRAWINGS

The technical characteristics of the invention, according to the aforesaid objects, and the advantages thereof, will be more evident in the following detailed description, made with reference to the enclosed drawings, which represent several merely exemplifying and non-limiting embodiments of the invention, in which:

FIG. 1A shows a schematic plan view of the filling machine, object of the present invention;

FIG. 1B shows a side view, partially in section, of a part of the filling machine, in accordance

with a first embodiment of the present invention;

FIG. 2 shows a sectional view of a valve group of the filling machine of FIG. 1B;

FIG. 3 shows a detail of FIG. 2 within the circle III;

FIG. 4 shows a sectional view of the valve group of the filling machine of FIG. 1, in accordance with a second embodiment of the first shutter;

FIG. 5 shows a detail of FIG. 4 within the circle V.

### DETAILED DESCRIPTION OF A PREFERRED EMBODIMENT

With reference to the enclosed drawings, reference number 1 overall indicates a filling machine for filling containers with liquids, object of the present invention.

Advantageously, the filling machine 1 is conventionally within a bottling plant downstream of a rinsing machine (not represented in the enclosed figures) and upstream of a capping machine (not represented in the enclosed figures). The containers to be filled are transferred by one machine to the other by means of transport lines, such as for example conveyor belts 17′, 17″, screws 18, star conveyors 19′, 19″ etc.

In particular, the containers are each provided on the upper part with a mouth through which the liquid is susceptible of being introduced within the container.

For example, the containers, generally constituted by bottles made of glass or PET, comprise a lower enlarged body from which an elongated neck is extended, terminating at the top with a head with the mouth through which the liquid is susceptible of being introduced within the container itself.

The present filling machine 1 can be employed for filling any other container type, such as for example cans, jars, etc.

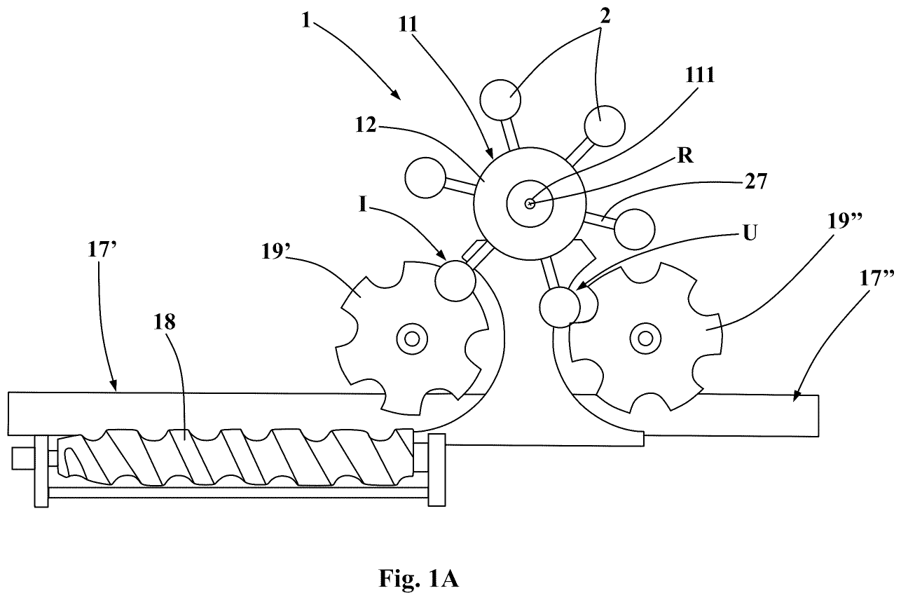

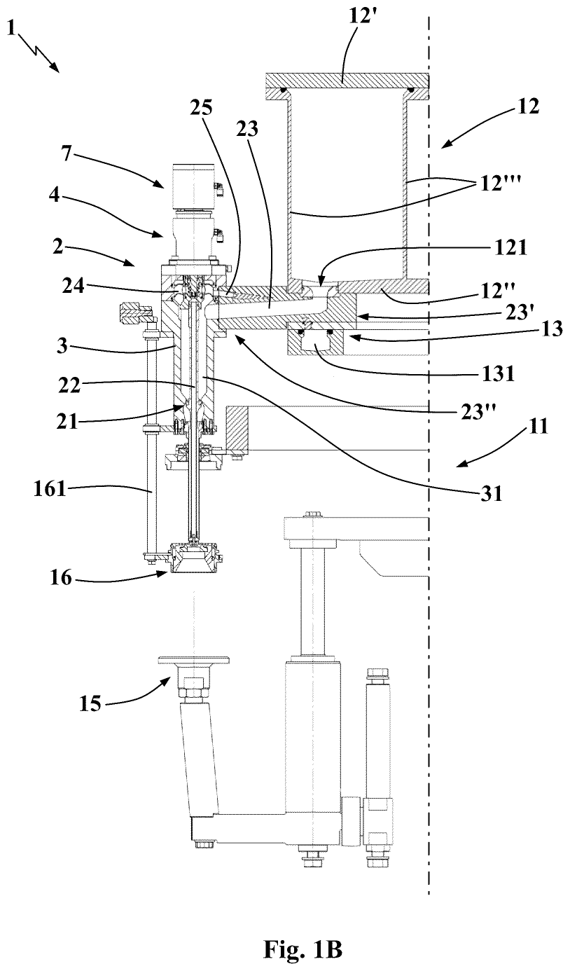

In a per se known manner, with reference to FIG. 1, the present filling machine 1 is advantageously provided with an inlet station I, at which it receives (preferably by means of a first star conveyor 19′ and/or an inlet screw 18) the containers to be filled, carried for example by a first conveyor belt 17 upstream. In addition, the filling machine 1 is provided with an outlet station, at which it releases (preferably by means of a second star conveyor 19″ and/or an outlet screw (not represented in the enclosed figures)) the filled containers, preferably ad a second conveyor belt 17″ downstream, adapted to convey such filled containers to the capping machine.

The present filling machine 1 comprises a rotary carousel 11 actuatable to rotate around a central rotation axis R, preferably vertical.

Advantageously, the filling machine 1 comprises a support structure (not represented in the enclosed figures), which is intended to be abutted against the ground and carries the aforesaid rotary carousel 11 rotatably mounted thereon. More in detail, the rotary carousel 11 is adapted to rotate around a central rotation shaft 111 thereof, preferably vertical, mounted on the support structure.

The filling machine 1 comprises, in addition, a containment tank 12, which is mounted on the rotary carousel 11 and adapted to contain at least one liquid to be bottled.

In this context, by containment tank 12 it can be intended any one hollow body fixed to the rotary carousel 11 and suitable for containing the liquid to be bottled. Optionally, the containment tank 12 can be fed, for example in a continuous or intermittent manner, by an auxiliary tank (not illustrated in the enclosed figures) of the bottling plant where the filling machine 1 is employed, which can be placed in a position that is spaced from the rotary carousel 11.

The containment tank 12 preferably has cylindrical or annular form and is fixed, coaxial with the rotary carousel 11, in order to rotate together with the latter during the operation of the filling machine 1. Advantageously, the containment tank 12 is delimited by an upper wall 12′, an opposite lower wall 12″ and at least one perimeter wall 12′″ placed to connect between the upper wall 12′ and the lower wall 12″.

The filling machine 1 comprises, in addition, a plurality of valve groups 2 peripherally mounted on the rotary carousel 11, advantageously hydraulically connected to the containment tank 12 in order to receive the liquid from the latter.

Preferably, the valve groups 2 are placed equidistant from each other around the central rotation axis R of the rotary carousel 11.

In a per se known manner, in order to fill a container with the liquid contained in the containment tank 12, the container itself, and in particular the head of the latter, is associated with the corresponding valve group 2 which is configured to convey the liquid from the containment tank 12 up to the container.

Each valve group 2 comprises a support body 3, which is fixed to the rotary carousel 11 and is provided with a supply channel 31. The supply channel 31 is in fluid connection with the containment tank 12 and is mainly extended along an extension axis X, preferably substantially vertical, from an upper end 31′ to a lower mouth 31″ through which the liquid is susceptible of being introduced into the container.

For example, in accordance with the embodiments illustrated in the enclosed figures, the lower mouth 31″ of the supply channel 31 projects on the lower part from the support body 3 of the valve group 2 and is susceptible of being inserted in the corresponding container in order to fill it with the liquid coming from the containment tank 12.

Advantageously, the supply channel 31 is intended to be connected in sealing relationship with the interior of the container to be filled.

For such purpose, in particular, the valve group 2 is provided with sealing means adapted to abut against the mouth of the container in order to isolate it from the outside environment. Such sealing means are per se of known type (for example comprising suitable gaskets placed on the support body 3 and/or on a centering cone 16 discussed hereinbelow) and thus are not discussed in more detail hereinbelow.

In addition, each valve group 2 comprises a conveyance duct 23, which is extended, at least partially, towards the central rotation axis R, advantageously transverse to the extension axis X, from the support body 3 to the containment tank 12 in order to connect the supply channel 31 to the containment tank 12 itself.

Advantageously, with reference to FIG. 1, the valve groups 2 are placed around the containment tank 12 outside the latter with respect to the rotation axis R of the rotary carousel 11.

In this manner, each valve group 2 is structurally separated from the containment tank 12, considerably facilitating the maintenance operations executed on the valve groups 2 themselves. Indeed, in order to execute the maintenance on a valve group 2, an operator acts directly on the latter without having to interact with the containment tank, reducing the time necessary for maintenance and preventing the containment tank 12 from being contaminated during the maintenance operations.

Advantageously, each conveyance duct 23 is extended (in particular at least partially radially with respect to the rotation axis R) between an internal end 23′ connected to the containment tank 12 and an external end 23″ connected to the supply channel of the valve group 2, in a manner such that, in particular, the support body 3 of the latter is spaced from the containment tank 12.

In addition, each valve group 2 comprises a first shutter 21 placed to intercept the supply channel 31.

Preferably, the first shutter 21 is arranged for taking on a first closed configuration, in which it prevents the passage of the liquid along the supply channel 31, and a first open configuration, in which it allows the passage of the liquid along the supply channel 31 in order to convey the liquid into the container to be filled.

In addition, each valve group 2 comprises a first actuator 4, which is mounted on the support body 3 and comprises a first actuation body 41, which is mechanically connected to the first shutter 21 and is movable along the extension axis X in order to actuate the first shutter 21 itself in order to open and close the supply duct 31.

In particular, the first actuation body 41 is arranged in order to move the first shutter 21 between the aforesaid closed configuration and open configuration.

Advantageously, in accordance with the enclosed figures, the first actuation body 41 is placed at least at the upper end 31′ of the supply channel 31.

Preferably, the first actuation body 41 is movable (in particular with respect to the support body 3) along the extension axis X between a first position, in which the first shutter 21 takes on the first closed configuration, and a second position, in which the first shutter 21 takes on the first open configuration.

Advantageously, when the first actuation body 41 is in the first position, this is placed at a height higher than when it is in the second position. In other words, when the first actuation body 41 is moved from the top downward, the first shutter 21 is opened, and when the first actuation body 41 is moved from the bottom upward, the first shutter 21 is closed.

Preferably, in accordance with the embodiments represented in the enclosed figures, the first actuator 4 comprises a first pneumatic actuator provided with a first piston which defines the aforesaid first actuation body 41.

The use of the first pneumatic actuator for moving the first shutter 21 is well known to the man skilled in the art and, therefore, will not be discussed in more detail hereinbelow.

Each valve group 2 comprises, in addition, a return tube 22, which is advantageously mechanically connected to the support body 3 and is placed at least partially to traverse the supply channel 31, preferably coaxial with the supply channel 31 itself.

The return tube 22 is susceptible of being partially inserted in the container in order to receive at least one gaseous fluid (such as for example air or inert gas) contained in the container itself, in particular during the filling of the latter.

In this manner, during the filling of the container, with the mouth of the container hermetically isolated with respect to the outside environment, the gaseous fluid is progressively substituted by the liquid and its evacuation by means of the return tube 22 prevents the formation of a counter-pressure within the container that would prevent the descent of the liquid at its interior.

Preferably, during the filling step, the return tube 22 is arranged for evacuating from the container, together with the aforesaid gaseous fluid, also a fraction of liquid, e.g. foam or the excess liquid poured into the container during the filling (through level adjustment operations that are per se of known type).

Advantageously, the return tube 22 is extended parallel to the extension axis X between a lower end portion 221, advantageously placed at the lower mouth 31″ of the supply channel 31, and an opposite upper end portion 222.

Advantageously, the return tube 22 is provided with an internal channel 225 extended between an inlet mouth 223 placed at the lower end portion 221 and an outlet mouth 224 placed at the upper end portion 222.

Advantageously, the inlet mouth 223 of the return tube 22 is arranged for being inserted within the container placed below the corresponding valve group 2 and is adapted to hydraulically adjust the maximum level of the liquid in the container itself.

Advantageously, in accordance with the embodiments represented in the enclosed figures, the filling machine 1 comprises multiple support plates 15 mounted on the rotary carousel 11, each positioned below the corresponding valve group 2, and susceptible of receiving in abutment the corresponding container, in order to convey it around the central rotation axis R of the rotary carousel 11.

In particular, each support plate 15 is movable parallel to the central rotation axis R with respect to the support body 3 of the corresponding valve group 2 in order to move the mouth of the container closer to the lower mouth 31″ of the supply channel 31.

Preferably, each valve group 2 comprises a centering cone 16, which is mounted on the support body 3 and is provided with a central hole traversed by the return tube 22 and advantageously by the supply channel 31 (in particular the section of the latter which projects on the lower part from the support body 3). For example, the centering cone 16 is supported by vertical rods 161 slidably mounted on the support body 3 of the corresponding valve group 2, so as to guide the lifting of the container (by means of the movement of the corresponding support plate 15) with the head of the latter aligned with the supply channel 31 and the return tube 22 of the valve group 2 itself.

The support plates 15 and the centering cones 16, and the operation thereof, are well known to the man skilled in the art and, therefore, they will not be discussed in more detail hereinbelow.

Each valve group 2 of the filling machine 1 comprises, in addition, an evacuation chamber 24, which is adapted to be placed in fluid communication with the return tube 22 and is traversed by the first actuation body 41 along the extension axis X.

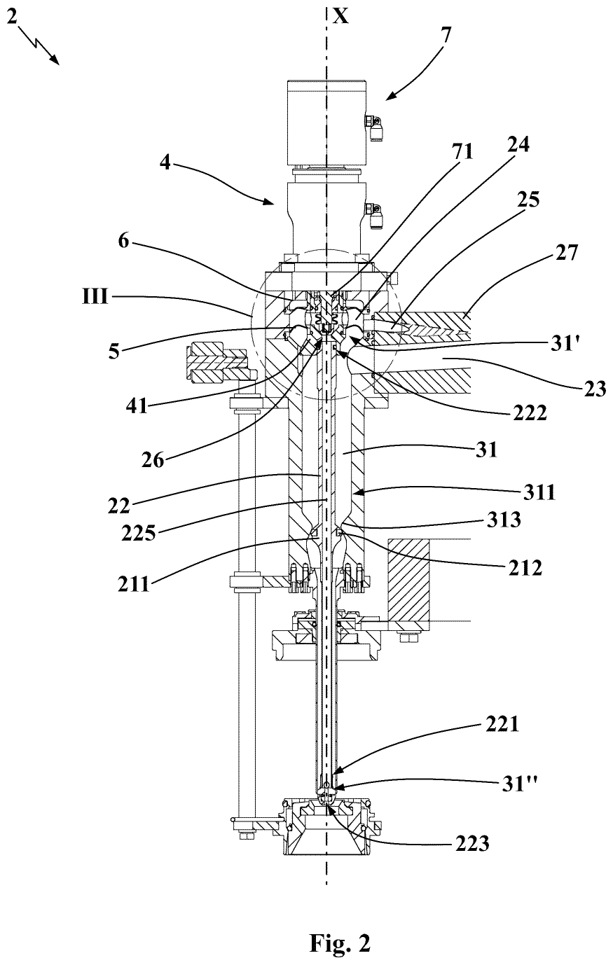

Advantageously, with reference to FIG. 2, the evacuation chamber 24 is placed at the upper end 31′ of the supply channel 31.

Preferably, the return tube 22 is in fluid connection with the evacuation chamber 24 by means of the outlet mouth 224.

The filling machine 1, object of the present invention, comprises, in addition, a return circuit 13, which is in fluid communication with the evacuation chamber 24 of each valve group 2 in order to receive the gaseous fluid, and preferably also the possible liquid fraction, coming from the return tube 22 of each valve group 2.

Advantageously, with reference to FIG. 1B, the return circuit 13 comprises a recovery tank 131, which is mounted on the rotary carousel 12 and preferably is extended with annular form around the central rotation axis R.

Optionally, the recovery tank 131 is in fluid connection with the containment tank 12, in particular by means of at least one recovery duct (not illustrated in the enclosed figures) intercepted by valve means, in order to send to the latter at least the fluid fraction that possibly ascends along the return tube 22, allowing the reuse of the liquid in the container filling process, avoiding waste.

Preferably, the return circuit 13 comprises treatment and filtering means (not illustrated in the enclosed figures), advantageously interposed between the recovery tank 131 and the containment tank 12 (in particular placed to intercept the recovery duct), in order to suitably retain the liquid, in particular before reinserting it in the containment tank 12.

Without departing from the protective scope of the present invention, the treatment and filtering means can be mounted directly on the rotary carousel 11 or they can be structurally separated therefrom depending on the preferred plant configuration.

The treatment and filtering means are well known to the man skilled in the art and, therefore, they will not be discussed in more detail hereinbelow.

Advantageously, the return circuit 13 comprises suction means (not illustrated in the enclosed figures) susceptible of generating reduced pressure at the evacuation chamber 24 of each valve group 2 so as to bring the interior of the container under reduced pressure, in accordance in particular with the operating principle of the filling machines, so-called “at slight vacuum”.

Advantageously, the action of the suction means facilitates the re-ascending of the gaseous fluid and of the possible liquid fraction along the return tube 22.

Without departing from the protective scope of the present invention, the filling machine 1, object of the present invention, can also be configured in accordance with the operating principle of the filling machines “with gravity” or “isobaric”.

According to the idea underlying the present invention, each valve group 2 comprises a first flexible membrane 5, which is placed as a hermetic closure of the upper end 31′ of the supply channel 31 to separate between the latter and the evacuation chamber 24. More in detail, the first flexible membrane 5 is extended, preferably mainly traverse to the extension axis X, between a first external edge 51 sealingly fixed to the support body 3 and a first internal edge 52 sealingly fixed to the first actuation body 41.

In addition, according to the idea underlying the present invention, each valve group 2 comprises a second flexible membrane 6, which is placed as an upper closure of the evacuation chamber 24 and is extended, preferably mainly traverse to the extension axis X, between a second external edge 61 sealingly fixed to the support body 3 and a second internal edge 62 sealingly fixed to the first actuation body 41.

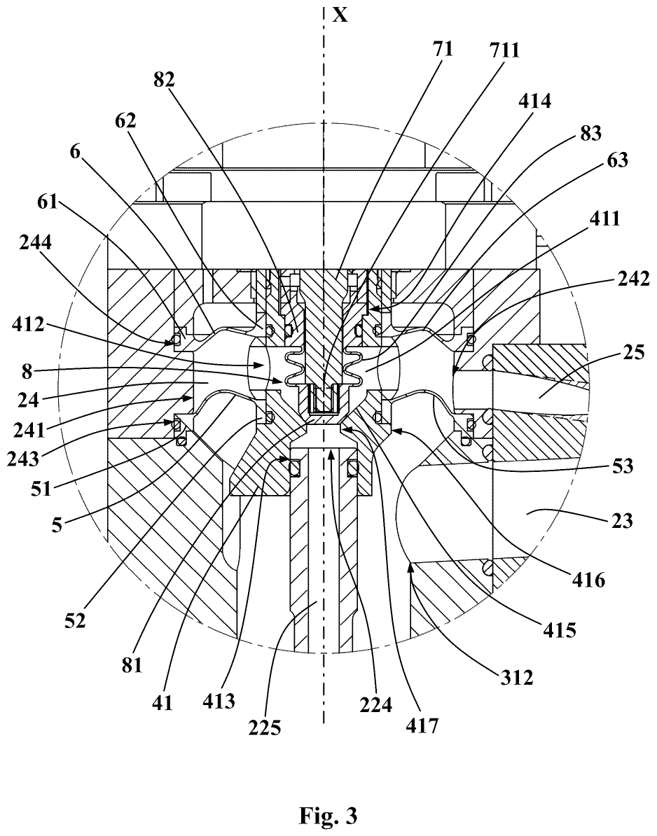

Advantageously, with reference to FIG. 3, the second flexible membrane 6 is placed spaced from the first flexible membrane 5 along the extension axis X and delimits, with the aforesaid first flexible membrane 5, the evacuation chamber 24 (according to the extension along the extension axis X).

More in detail, the first flexible membrane 5 and the second flexible membrane 6 are arranged for being deformed by the first actuation body 41 when it is moved along the extension axis X (in particular in order to open and close the first shutter 21).

In this manner, the claimed configuration of the flexible membranes 5, 6, with the internal edges 52, 62 that are fixed to the first actuation body 41 and the external edges 51, 61 that are fixed to the support body 3, ensures that the flexible membranes 5, 6 are deformed in response to the movement of the first actuation body 41 in order to allow the movement thereof without ever coming into dragging contact with other surfaces. Consequently, such configuration of the flexible membranes 5, 6 prevents the wear from dragging which the abovementioned gaskets (in particular lip gaskets) of the prior art have, considerably reducing the wear effects and thus the frequency of maintenance interventions on the filling machine 1 and, therefore, increasing the operative efficiency of the filling machine 1 itself.

In addition, the deformation of the flexible membranes 5, 6 following the movement of the first actuation body 41 prevents the formation on the latter of stagnant areas where the liquid could be deposited for a long time, making it difficult to achieve an effective cleaning. This aspect is important for preventing the risk of contamination of the liquid that comes into contact with the flexible membranes 5, 6 themselves during the filling of the containers, thus ensuring a safer and more hygienic filling process.

Advantageously, the first flexible membrane 5 and the second flexible membrane 6 are made of polymer material with high chemical inertia. In this manner, the material constituting the flexible membranes 5, 6 does not react with the liquid that transits along the supply channel 31, preventing possible contaminations of the liquid itself.

Preferably, the first flexible membrane 5 and the second flexible membrane 6 are made of polytetrafluoroethylene (PTFE).

Advantageously, the first flexible membrane 5 is arranged for taking on a first deformed configuration when the first actuation body 41 is in the first position, and a second deformed configuration when the first actuation body 41 is in the second position. Preferably, when the first actuation body 41 is moved between the first position and the second position (and vice versa), the first flexible membrane 5 is progressively deformed in a continuous manner by passing from the first deformed configuration to the second deformed configuration (and vice versa).

Advantageously, in particular in a manner analogous to the first flexible membrane 5, the second flexible membrane 6 is arranged for taking on a third deformed configuration when the first actuation body 41 is in the first position, and a fourth deformed configuration when the first actuation body 41 is in the second position. Preferably, when the first actuation body 41 is moved between the first position and the second position (and vice versa), the second flexible membrane 6 is progressively deformed in a continuous manner by passing from the third deformed configuration to the fourth deformed configuration.

In this manner, the progressive and continuous deformation of the flexible membranes 5, 6 during the movement of the first actuation body 41 between the first and the second position allows reducing, to a minimum, the local stresses on the flexible membranes 5, 6 themselves, prolonging the duration thereof and preventing the onset of critical wear points.

Advantageously, the first flexible membrane 5 comprises a first sheet-like portion 53 which connects the first external edge 51 and the first internal edge 52 of the first flexible membrane 5 itself and is arrange for being bent following the movement of the first actuation body 41. Analogously, the second flexible membrane 6 comprises a second sheet-like portion 63 which connects the second external edge 61 and the second internal edge 62 of the second flexible membrane 6 itself and is arranged for being bent following the movement of the first actuation body 41.

Advantageously, in accordance with FIG. 3, the supply channel 31 is provided with a first lateral wall 311 which is extended around the extension axis X and is provided with at least one inlet opening 312 which connects the supply channel 31 to the conveyance duct 23.

In this manner, the liquid coming from the containment tank 12 through the conveyance duct 23 enters into the supply channel 31 transversely with respect to the extension axis X.

Advantageously, the inlet opening 312 is attained at the upper end 31′ of the supply channel 31, in particular at a height lower than the first membrane 5.

Preferably, the conveyance duct 23 is extended starting from the inlet opening 312 of the support body 3 up to a feed opening 121 made on the containment tank 12, in particular at the lower wall 12″ of the latter.

Advantageously, each valve group 2 comprises a connection body 27, which is fixed to the rotary carousel 11, is extended mainly radially with respect to the central rotation axis R and carries, fixed thereto, the corresponding support body 3.

Preferably, the conveyance duct 23 is made in the aforesaid connection body 27.

Advantageously, the support body 3 is fixed to the connection body 27 by means of removable fixing means, such as for example screw means. In this manner, with the filling machine 1, object of the present invention, it is possible to dismount and remount the support body 3 of each valve group 2, for example in order to execute maintenance of the same, in quick and easy manner, reducing the machine time due to the maintenance operations.

Advantageously, the evacuation chamber 24 of each valve group 2 is provided with a second lateral wall 241, which is extended around the extension axis X and is provided with an outlet opening 242 which connects the evacuation chamber 24 to the return circuit 13.

In this manner, the gaseous fluid and the possible liquid fraction, that ascend the return tube 22 during the filling of the container up to reaching the evacuation chamber 24, exit from the latter transversely with respect to the extension axis X.

Advantageously, the first actuation body 41 is provided with a lateral surface 416 which is extended around the extension axis X and on which the first and the second internal edge 52, 62, respectively of the first and second flexible membrane 5, 6, are fixed. In particular, the aforesaid lateral surface 416 is directed towards the second lateral wall 241 of the evacuation chamber 24 and advantageously delimits, together with such second lateral wall 241, the extension of the evacuation chamber 24 in radial direction with respect to the extension axis X.

Advantageously, the evacuation chamber 24 has substantially annular shape in particular with annular extension around the extension axis X.

Preferably, each valve group 2 is provided with a return duct 25 which is at least partially extended towards the central rotation axis R, from the outlet opening 242 of the evacuation chamber 24 to the return circuit 13, and in particular up to the recovery tank 131 of the latter.

In this manner, the gaseous fluid and the possible liquid fraction, that ascend the return tube 22 during the filling of the container up to reaching the evacuation chamber 24, ascent the return circuit 13 through the corresponding outlet opening 242 and the return duct 25.

Advantageously, in accordance with FIG. 2, the return duct 25 is made on the corresponding connection body 27.

Preferably, the first external edge 51 of the first flexible membrane 5 and the second external edge 61 of the second flexible membrane 6 are fixed to the second lateral wall 241 of the evacuation chamber 24.

Advantageously, with reference to FIG. 3, the second lateral wall 241 comprises a first annular seat 243, which is extended around the extension axis X and is engaged (in retention relation) at its interior by the first external edge 51 of the first flexible membrane 5.

Preferably, the first external edge 51 is retained in the first annular seat 243 via shape coupling. In this manner, the first external edge 51 is stably retained in the first annular seat 243 and the hermetic seal is ensured between the first external edge 51 itself and the second lateral wall 241 of the evacuation chamber 24.

Advantageously, the second lateral wall 241 comprises a second annular seat 244, which is extended around the extension axis X and is engaged (in retention relation) with its interior by the second external edge 61 of the second flexible membrane 6.

Preferably, the second external edge 61 is retained in the second annular seat 244 via shape coupling. In this manner, the second external edge 61 is stably retained in the second annular seat 244 and the hermetic seal is ensured between the second external edge 61 itself and the second lateral wall 241 of the evacuation chamber 24.

Advantageously, with reference to FIG. 3, the first actuation body 41 is provided with a connection passage 411 which places in fluid communication the return tube 22 and the evacuation chamber 24.

Preferably, the connection passage 411 is provided with at least one first connection opening 412 which places it in fluid communication with the evacuation chamber 24, and is advantageously provided with at least one second connection opening 417 which places it in fluid communication with the internal channel 225 of the return tube 22.

Preferably, the first connection opening 412 is attained on the lateral surface 416 of the first actuation body 41, in particular on one section of such lateral surface 416 which is extended between the first internal edge 52 of the first flexible membrane 5 and the second internal edge 62 of the second flexible membrane 6.

Advantageously, the second connection opening 417 of the connection passage 411 is directed towards the upper end portion 222 of the return tube 22 and, in particular, is aligned with the extension axis X.

Advantageously, the first actuation body 41 comprises an abutment wall 415, which is extended, along the extension axis X, between the first and the second connection opening 412, 417 and, preferably, has tapered form approaching the extension axis X, proceeding along the latter towards the upper end portion 222 of the return tube 22.

Advantageously, the first actuation body 41 comprises a first longitudinal channel 413, which is extended parallel to the extension axis X starting from the second connection opening 417 of the connection passage 411 downward (in particular towards the lower mouth 31″ of the supply channel 31).

Preferably, the upper end portion 222 of the return tube 22 is placed at least partially in the first longitudinal channel 413 of the first actuation body 41.

Advantageously, the upper end portion 222 of the return tube 22 is fixed, preferably in a removable manner, to the first actuation body 41. In this manner, the return tube 22 is moved parallel to the extension axis X integral with the advancement body 41.

Preferably, the return tube 22 is removably fixed to the first actuation body 41 by means of a quick coupling system, such as for example a bayonet coupling. In this manner, during the maintenance of the filling machine 1, object of the present invention, an operator can remove and install the return tube 22 with respect to the corresponding valve group 2 in a quick manner, hence reducing the machine stop time in order to execute the aforesaid maintenance. Advantageously, such characteristic also allows the substitution of the return tube 22 without having to dismount other components of the filling machine 1, in particular without having to intervene on the first and second flexible membrane 5, 6, thus preventing the damage or the wear of the same.

Advantageously, the return tube 22 carries, fixed thereto, the first shutter 21. In this manner the movement of the first actuation body 41 is transmitted to the first shutter 21 by the return tube 22 itself.

Preferably, in accordance with the embodiments represented in the enclosed figures, the first shutter 21 comprises a blocking body 211 fixed to the return tube 22, which, when the first shutter 21 takes on the first closed configuration, is arranged to seal against the first lateral wall 311 of the supply channel 31 in order to prevent the passage of the liquid along the latter.

Advantageously, the blocking body 211 is extended projecting with respect to the extension axis X from the return tube 22.

Preferably, the blocking body 211 is attained in a single body with the return tube 22.

Advantageously, the first shutter 21 comprises at least one gasket 212, in particular annular, extended preferably around the extension axis X, which is fixed to the blocking body 211 in order to ensure the seal between the blocking body 211 itself and the first lateral wall 311 of the supply channel 31 when the first shutter 21 takes on the first closed configuration.

Preferably, when the first shutter 21 takes on the first closed configuration, this divides the supply channel 31 into a wet upper section, within which the liquid coming from the containment tank 12 is present, and one dry lower section, at which the liquid is not present. Advantageously, the division between wet upper section and dry lower section of the supply channel 31 is defined by the gasket 212.

Advantageously, in accordance with a first embodiment represented in FIGS. 1B and 2, the blocking body 211 is fixed to the return tube 22 spaced from the the lower end portion 221 of the latter.

Preferably, the first lateral wall 311 of the support body 3 comprises an abutment portion 313, which is extended projecting towards the interior of the supply channel 31, defining a narrow section of the supply channel 31.

Advantageously, when the first actuation body 41 is in the first position, the blocking body 211 (and in particular the gasket 212 fixed thereto) is placed in abutment against the abutment portion 313 of the first lateral wall 311, preventing the passage of the liquid through the supply channel 31.

Preferably, when the first actuation body 41 is in the second position, the blocking body 211 is placed spaced from the abutment portion 313 and, hence, the liquid is free to transit along the supply channel 31 towards the lower mouth 31″.

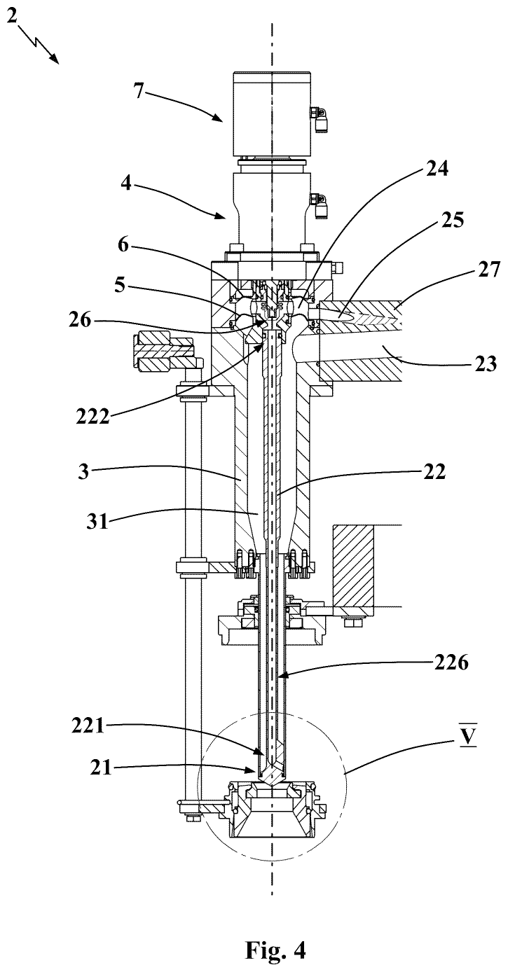

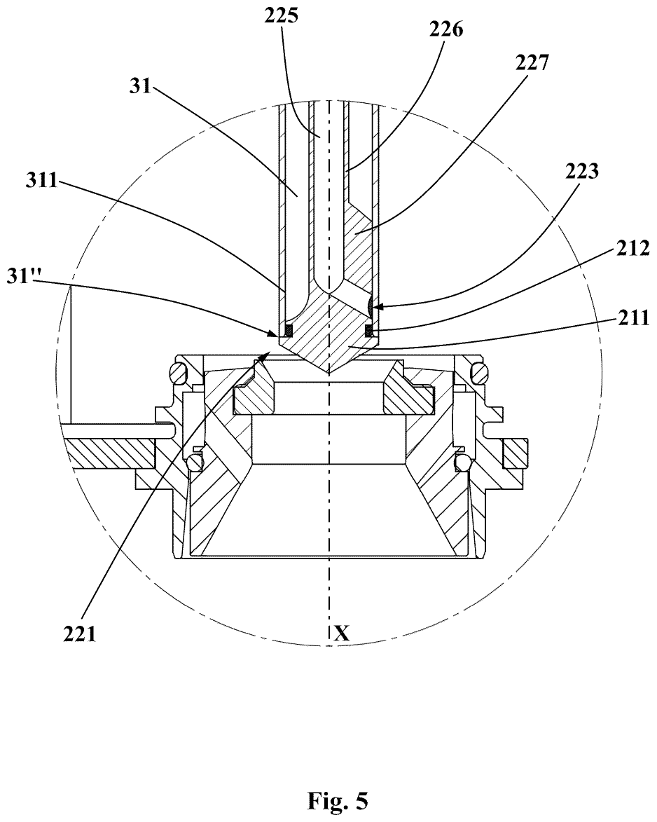

Advantageously, in accordance with a second embodiment of the invention represented in FIGS. 4 and 5, the first shutter 21, and in particular the blocking body 211, is fixed to the lower end portion 221 of the return tube 22.

Preferably, when the first actuation body 41 is in the first position (and hence the first shutter 21 is in the first closed configuration), the blocking body 211 sealingly closes the lower mouth 31″ of the supply channel 31. In particular, in such position, the blocking body 211 is placed at least partially within the supply channel 31 at the lower mouth 31″ of the latter. In such situation, the gasket 212 fixed to the blocking body 211 is advantageously placed within the supply channel 31 and seals against the first lateral wall 311 of the latter, preventing the passage of the liquid through the lower mouth 31″ of the supply channel 31.

Advantageously, when the first actuation body 41 is in the second position (and hence the first shutter 21 is in the first open configuration), the blocking body 211 is placed spaced from the lower mouth 31″ of the supply channel 31 in particular outside the latter, allowing the liquid to pass through the lower mouth 31″.

Advantageously, with reference to FIG. 5, according to the aforesaid second embodiment, the inlet mouth 223 of the return tube 22 is placed at the lower end portion 221 at a height higher than the first shutter 21.

Preferably, the inlet mouth 223 is placed at a height higher than the gasket 212 of the first shutter 21.

Advantageously, with reference to FIG. 5, the return tube 22 is provided with a third lateral wall 226 that is extended around the extension axis X and on which the aforesaid inlet mouth 223 is attained. Preferably, the inlet mouth 223 is attained above the blocking body 211 of the first shutter 21.

Advantageously, each valve group 2 comprises a deflection body 227, which is fixed to the return tube 22, is extended projecting from the third lateral wall 226 outside the internal channel 225 and is placed at the inlet mouth 223, above this. Preferably, the deflection body 227 is integrally made with the return tube 22.

In this manner, when the first shutter 21 takes on the first open configuration, the deflection body 227 deflects the liquid that falls along the supply channel 31 far from the inlet mouth 223. Such characteristic results particularly advantageous in the event in which the suction means of the return circuit 13 are active, preventing the liquid itself from being suctioned into the return tube 22 before reaching the container due to the reduced pressure at the evacuation chamber 24 generated by the suction means.

Advantageously, with the first shutter 21 in the first closed configuration, the inlet mouth 223 of the return tube 22 is placed within the supply channel 31 and places the internal channel 225 of the return tube 22 itself in fluid connection with the supply channel 31 in order to allow a recirculation of the liquid from the supply channel 31 to the return circuit 13 through the return tube 22 and the evacuation chamber 24. Preferably, the return tube 22 is provided with a small connection channel (not illustrated in the enclosed figures, made for example in the deflection body 227), which places the inlet mouth 223 of the return tube 22 in communication with the supply channel 31.

Such characteristic is particularly advantageous in the event in which the filling machine 1, object of the present invention, is employed for filling the containers with a liquid, such as for example a fruit juice, that requires being sealed at a temperature greater than a specific threshold temperature during the entire filling step, in order to ensure the sterility and the organoleptic properties of the liquid itself. Such operation is known in the technical jargon with the expression “hot filling”.

In particular, the recirculation of the liquid is essential in order to prevent that, in the case for example of a machine stop due to any type of drawback, the liquid present in the supply channel 31, and in particular in the wet upper section, remains stagnant and is cooled, descending below the threshold temperature, comprising the sterility thereof and the quality of the liquid itself. In addition, in such possible machine stop situation, the continuous recirculation of the liquid ensures a thermal uniformity along the supply channel 31, reducing the risk of formation of cold zones that could compromise the effectiveness and the quality of the bottling process. Therefore, this configuration optimizes the maintenance of the operating conditions required for a safe and effective hot filling.

Preferably, each valve group 2 comprises a second shutter 26 placed, at least partially, within the connection passage 411 of the first actuation body 41.

Advantageously, each valve group 2 comprises a second actuator 7 provided with a second actuation body 71, which is provided with an operative end 711 carrying the second shutter 26 mounted thereon and is movable parallel to the extension axis X in order to move the second shutter 26 to open and close the connection passage 411, so as to respectively connect or isolate the return tube 22 to/from the evacuation chamber 24.

Preferably, the second shutter 26 is configured for taking on a second closed configuration, in which it prevents the passage of fluid through the connection passage 411, and a second open configuration, in which it allows the passage of fluid along the supply channel 31.

Preferably, in accordance with the embodiments represented in the enclosed figures, the second actuator 7 is mounted on the first actuation body 41 of the first actuator 4.

In this manner, a compact configuration is obtained, in which the second actuator 7 is moved integrally with the first actuation body 41 of the first actuator 4, reducing the structural complexity and the number of necessary components and ensuring an optimal synchronization between the movements of the two actuation bodies 41, 71 during the operation of the filling machine 1, object of the present invention.

Advantageously, the second actuation body 71 is movable along the extension axis X between a lowered position, in which the second shutter 26 takes on the second closed configuration, and a raised position, in which the second shutter 26 takes on the second open configuration.

Advantageously, the first actuation body 41 comprises a second longitudinal channel 414 extended along the extension axis X starting from the connection passage 411 upward (in particular away from the outlet mouth 224 of the return tube 22).

Preferably, the second actuation body 71 is slidably inserted at least partially in the second longitudinal channel 414 of the first actuation body 41 with the operative end 711 placed within the connection passage 411.

Preferably, in accordance with the embodiments represented in the enclosed figures, the second actuator 7 comprises a second pneumatic actuator provided with a second piston which defines the aforesaid second actuation body 71.

The use of the second pneumatic actuator for the movement of the second shutter 26 is well known to the man skilled in the art and, therefore, will not be discussed in more detail hereinbelow.

Preferably, the second shutter 26 comprises a covering cap 8 provided with a head portion 81 fixed to the operative end 711 of the second actuation body 71, in particular placed to enclose the operative end 711.

In addition, the covering cap 8 preferably comprises an end edge 82 sealingly fixed to the first actuation body 41 with hermetic upper closure of the connection passage 411, and a flexible connection portion 83 which connects the head portion 81 to the end edge 82 to cover one section of the second actuation body 71 extended between the head portion 81 and the end edge 82.

Advantageously, the connection portion 83 of the covering cap 8 is arranged for being deformed by the second actuation body 71 moved parallel to the extension axis X.

In this manner, the fact that the end edge 82 of the covering cap 8 is fixed to the first actuation body 41 and the head portion is fixed to the second actuation body 71 ensures that the connection portion 83 is only deformed in response to the relative movement of the first actuation body 41 and of the second actuation body 71 without ever coming into dragging contact with other surfaces. Consequently, such configuration allows hermetically closing the connection passage 411 of the first actuation body 41 without having to employ dragging gaskets (such as for example lip gaskets), considerably reducing the frequency of the maintenance interventions on the filling machine 1 and, therefore, increasing the operative efficiency of the operative machine 1 itself.

Preferably, with reference to FIG. 3, the connection portion 83 is extended between the head portion 81 and the end edge 82 with a bellows configuration, in particular being provided with multiple undulated folds that allow such connection portion 83 to be elongated or shortened (without being broken). In this manner, the bellows shape allows uniformly absorbing and distributing the stresses generated by the movement of the head portion 81 with respect to the end edge 82, reducing the risk of permanent deformations or breakage in the connection portion 83 itself and ensuring greater durability and reliability of the covering cap 8.

Advantageously, when the second actuation body 71 is in the lowered position, the head portion 81 of the covering cap 8 closes the second connection opening 417 of the connection passage 411 and, in particular, is placed in abutment against the abutment wall 415 of the first actuation body 41. In this manner, in particular by means of the coupling between the head portion 81 and the abutment wall 415, the second shutter 26 in the second closed configuration hermetically isolates the outlet mouth 224 of the return tube 22 from the connection passage 411, isolating the return tube 22 from the evacuation chamber 24.

Preferably, when the second actuation body 71 is in the raised position, the head portion 81 of the covering cap 8 is placed spaced from the second connection opening 417 of the connection passage 225 (and in particular from the abutment wall 415 of the first actuation body 41). In this manner, the return tube 22 is placed in fluid connection with the evacuation chamber 24 through the connection passage 411.

The invention thus conceived therefore attains the pre-established objects.

The contents of the Italian application number 102024000029250, from which this application claims priority, are incorporated herein by reference.

1. A filling machine for filling containers with liquids, said filing machine comprising:
a rotary carousel (11) actuatable to rotate around a central rotation axis (R);
a containment tank (12) mounted on said rotary carousel (11) and adapted to contain a liquid to be bottled;
a plurality of valve groups (2) peripherally mounted on said rotary carousel (11) and comprising:
a support body (3) fixed to said rotary carousel (11) and provided with a supply channel (31), which is in fluid connection with said containment tank (12) and is mainly extended along an extension axis (X) from an upper end (31′) to a lower mouth (31″) through which said liquid is susceptible of being introduced in a container to be filled;
a conveyance duct (23), which is extended, at least partially, towards said central rotation axis (R), from said support body (3) to said containment tank (12) in order to connect said supply channel (31) to said containment tank (12);
a first shutter (21) placed to intercept said supply channel (31);
a first actuator (4) mounted on said support body (3) and comprising a first actuation body (41), which is mechanically connected to said first shutter (21) and is movable along said extension axis (X) in order to actuate said first shutter (21) in order to open and close said supply duct (31);
a return tube (22) placed at least partially to traverse said supply channel (31) and susceptible of being partially inserted in said container in order to receive at least one gaseous fluid contained in said container; wherein said return tube (22) is extended parallel to said extension axis (X) between a lower end portion (221) and an opposite upper end portion (222) which is fixed to said first actuation body (41);
an evacuation chamber (24) adapted to be placed in fluid communication with said return tube (22) and traversed by said first actuation body (41) along said extension axis (X);
a return circuit (13), which is in fluid communication with said evacuation chamber (24) of each said valve group (2) in order to receive said at least one gaseous fluid coming from said return tube (22) of each said valve group (2);
wherein said valve group (2) comprises:
a first flexible membrane (5), which is placed as a hermetic closure of the upper end (31′) of said supply channel (31) to separate between said supply channel (31) and said evacuation chamber (24), and is extended between a first external edge (51) fixed in a sealed manner to said support body (3) and a first internal edge (52) fixed in a sealed manner to said first actuation body (41);
a second flexible membrane (6), which is placed as an upper closure of said evacuation chamber (24) and is extended between a second external edge (61) fixed in a sealed manner to said support body (3) and a second internal edge (62) fixed in a sealed manner to said first actuation body (41);
said first flexible membrane (5) and said second flexible membrane (6) being arranged for being deformed by said first actuation body (41) moved along said extension axis (X).

2. The filing machine of claim 1, wherein said supply channel (31) is provided with a first lateral wall (311) extended around said extension axis (X) and provided with at least one inlet opening (312) which connects said supply channel (31) to said conveyance duct (23).

3. The filing machine of claim 1, wherein said valve groups (2) are placed around said containment tank (12) outside said containment tank (12) with respect to the rotation axis (R) of said rotary carousel (11).

4. The filing machine of claim 1, wherein said evacuation chamber (24) is provided with a second lateral wall (241) extended around said extension axis (X) and provided with an outlet opening (242) that connects said evacuation chamber (24) to said return circuit (13).

5. The filing machine of claim 4, wherein each said valve group (2) is provided with a return duct (25) which is at least partially extended towards said central rotation axis (R), from the outlet opening (242) of said suction chamber (24) to said return circuit (13).

6. The filing machine of claim 4, wherein the first external edge (51) of said first flexible membrane (5) and the second external edge (61) of said second flexible membrane (6) are fixed to the second lateral wall (241) of said evacuation chamber (24).

7. The filing machine of claim 1, wherein said first actuation body (41) is provided with a connection passage (411) which places said return tube (22) and said evacuation chamber (24) in fluid communication.

8. The filing machine of claim 7, wherein each valve group (2) comprises:
a second shutter (26) placed, at least partially, within the connection passage (411) of said first actuation body (41);
a second actuator (7) provided with a second actuation body (71) provided with an operative end (711) carrying said second shutter (26) mounted thereon and movable parallel to said extension axis (X) in order to move said second shutter (26) to open and close said connection passage (411);
wherein said second shutter (26) comprises a covering cap (8) provided with:
a head portion (81) fixed to the operative end (711) of said second actuation body (71);
an end edge (82) fixed in a sealed manner to said first actuation body (41) as a hermetic upper closure of said connection passage (411);
a flexible connection portion (83), which connects said head portion (81) to said end edge (82) to cover one section of said second actuation body (71) extended between said head portion (81) and said end edge (82), and is arranged for being elastically deformed by said second actuation body (71) moved parallel to said extension axis (X).

9. The filing machine of claim 1, wherein said return tube (22) carries, fixed thereto, said first shutter (21) and is extended parallel to said extension axis (X) between a lower end portion (221) and an upper end portion (222) fixed to said first actuation body (41).

10. The filing machine of claim 9, wherein:
said first shutter (21) is fixed to the lower end portion (221) of said return tube (22) and is arranged for taking on a first closed configuration, in which said first shutter (21) prevents the passage of the liquid along said supply channel (31), and a first open configuration, in which said first shutter (21) allows the passage of the liquid along said supply channel (31);
said return tube (22) is provided with an internal channel (225) extended starting from an inlet mouth (223) placed at said lower end portion (221) and at a height higher than said first shutter (21);
wherein, with said first shutter (21) in said first closed configuration, the inlet mouth (223) of said return tube (22) is placed within said supply channel (31) places said internal channel (225) in fluid connection with said supply channel (31) in order to allow a recirculation of said liquid from said supply channel (31) to said return circuit (13) through said return tube (22) and said evacuation chamber (24).

11. The filing machine of claim 1, wherein the upper end portion (222) of said return tube (22) is fixed, in a removable manner, to said first actuation body (41).

12. The filing machine of claim 11, wherein said return tube (22) is removably fixed to said first actuation body (41) by means of a quick coupling system.
